(19) United States
(12) Patent Application Publication
(10) Pub. No.: US 2015/0068984 A1
(43) Pub. Date: Mar. 12, 2015

(54) SYSTEM AND METHOD FOR TREATMENT OF SPENT CAUSTIC WASTEWATER

(71) Applicants: Envirosystems Inc., Dartmouth (CA); Ultrasonic Systems GmbH, Thierhaupten (DE)

(72) Inventors: Veselin Milosevic, Bedford (CA); Fernando Naranjo, Dartmouth (CA); Kosanic Drago, Halifax (CA); Jack Zarczynski, Halifax (CA); Clint Stewart, Head of Chezzetcook (CA)

(21) Appl. No.: 14/485,327

(22) Filed: Sep. 12, 2014

Related U.S. Application Data
(60) Provisional application No. 61/877,273, filed on Sep. 12, 2013.

(51) Int. Cl. C02F 1/72; C02F 1/66; C02F 1/78

(52) U.S. Cl. CPC C02F 1/722; C02F 1/725; C02F 1/78; C02F 1/66; C02F 2305/02
USPC 210/748.02; 210/198.1; 210/192; 210/178

(57) ABSTRACT

The present disclosure relates to a process for treating and regenerating a spent caustic solution at ambient temperatures and pressure which includes oxidizing spent caustic wastewater with a hydrogen-peroxide/ozone mixture, supported by a board rang irradiation of the spent caustic wastewater by ultrasound. A range of wastewater treatment techniques may also be included to reach a desired effluent quality level.

### CROSS-REFERENCE TO OTHER APPLICATIONS

This application claims the benefit of U.S. Provisional Application No. 61/877,273 filed Sep. 12, 2013, which is hereby incorporated by reference.

### TECHNICAL FIELD

The present disclosure relates to wastewater treatment, and more particularly to a system and method for treatment of spent caustic wastewater.

### BACKGROUND

Spent caustic wastewater is an aqueous waste stream when petroleum derived fluids are processed with aqueous sodium hydroxide. It is formed out of scrubbing processes where excess sulfur compounds are removed from refined mid and final products, creating a stream with very high amounts of hydrogen-sulfide, organic disulfides, phenolics, mercaptans, and other hydrocarbon compounds. In addition, high residual sodium-hydroxide makes pH range from 11-14. The spent caustic wastewater produced from this processing is typically dark brown in color, turbid, highly alkaline, contains high levels of sulfides and has a pungent odor characteristic of olefins and sulfides.

Spent caustic wastewater handling, treatment and disposal is a major concern for oil refining and olefins production facilities due to their hazardous nature and noxious properties. As sources of spent caustic generation are diverse, they produce characteristically different wastewater streams of inorganic and organic acidic compounds such as carbon-dioxide sulfides, carbonates, mercaptans, phenolics, cresylics and naphthenates. Most of these compounds are acidic and must be removed from the process to avoid corrosion of downstream equipment and to prevent or reduce the likelihood of poisoning catalysts.

Although both oil refineries and petrochemical plants generate a wastewater stream that belongs to this category, the actual chemical composition of these wastewater streams varies significantly from one plant to another depending on site deployed refining/purification processes. For example, the oil refining spent caustic stream comes from multiple sources, and includes sulfidic, naphthenic, and cresylic spent caustic waters. Sulfidic spent caustic is generated by a scrubbing process of liquefied petroleum gas (LPG) and pentane from catalytic cracker (FCC), as well as continuous distillation unit (CDU). Naphthenic spent caustic comes from the Merox® type treatment of kerosene. On the other hand, cresylic spent caustic comes from the Merox® type treatment of visbreaker gasoline.

The spent caustic is considered one of the most difficult streams to handle by wastewater treatment industry professionals. Typical conventional treatment options range from steam and/or air stripping, chemical oxidation to oxidation supported by high pressure and incineration. Disadvantages of using these techniques relate to high capital deployment per unit basis, high operating costs, incomplete treatment requiring additional treatment steps and associated safety concerns.

Therefore, there is provided a novel method and system for treating spent caustic wastewater which overcomes disadvantages of the prior art.

### SUMMARY

The disclosure is directed at an improved system and method for treating a wastewater stream containing inorganic and organic impurities. More specifically, the disclosure relates to method for treating spent caustic wastewater to provide an effluent quality level suitable for discharge into the environment and/or regeneration of the spent caustic solution.

A process for treating spent caustic comprises steps of oxidation of the spent caustic wastewater while exposing the spent caustic wastewater to ultrasound cavitation under intense mixing conditions where sulfur-based compounds are converted into benign compounds (mostly sulfates). The process also includes chemical adjustment/treatment where wastewater pH is adjusted to meet downstream treatment and handling requirements, and additional treatments and/or polishing, where residual contaminants are removed to meet wastewater discharge criteria.

One advantage of the current disclosure is the combination of chemical oxidation and ultrasound irradiation for the treatment of spent caustic wastewater.

In one aspect of the disclosure, there is provided a system for treating spent caustic wastewater including a treatment system having a hydrogen peroxide apparatus for mixing hydrogen peroxide with the spent caustic wastewater; an oxygen treatment apparatus for mixing ozone with the spent caustic wastewater; a pH adjustment apparatus for mixing acid with the spent caustic wastewater; an agitator for providing a mechanical catalyst to an output of the oxygen treatment apparatus; an ultrasound apparatus to assist in accelerating chemical reactions between the spent caustic wastewater and the ozone; wherein the combination of hydrogen peroxide, ozone and spent caustic wastewater and the mechanical catalyst produce a treated wastewater.

In another aspect, there is provided a method of treating spent caustic wastewater including adding hydrogen peroxide to the spent caustic wastewater; adding ozone to the spent caustic wastewater; applying a mechanical catalyst to the mixture of hydrogen peroxide, ozone and spent caustic wastewater to accelerate chemical reactions; applying ultrasound cavitation to the mixture; and adding an acid to the mixture to balance a pH of the mixture.

### BRIEF DESCRIPTION OF THE DRAWINGS

These and other features will become more apparent from the following description in which reference is made to the appended drawings wherein:

FIG. 1 is a schematic diagram of a first embodiment of a system for treating spent caustic wastewater;

FIG. 2 is a schematic diagram of a second embodiment of a system for treating spent caustic wastewater;

FIG. 3 is a schematic diagram of apparatus for further treatment or treated spent caustic wastewater;

FIG. 4 a schematic diagram of another apparatus for further treatment or treated spent caustic wastewater;

FIG. 5 is a flowchart outlining a method of treating spent caustic wastewater in accordance with the system of FIG. 1; and

FIG. 6 is a flowchart outlining a method of treating spent caustic wastewater in accordance with the system of FIG. 2.

### DETAILED DESCRIPTION

The disclosure is directed at a system and method for treating spent caustic wastewater. While the disclosure has a wide application range for the removal of inorganic and organic impurities from spent caustic wastewater, the current disclosure focuses on the treatment of oil refining spent caustic wastewater. In a preferred embodiment, the disclosure includes the use of peroxide, ozone and ultrasonic vibrations or irradiation in the treatment of this wastewater. In one embodiment, the treatment process includes three (3) operating functions whereby during each function, the wastewater is sampled and analyzed, at regular intervals, for total sulfide content and pH. The function that is utilized to treat the spent caustic wastewater is dependent upon the particular chemical characteristics of the wastewater being treated.

These three operating functions include, but are not limited to, a peroxone reaction function, an ozone-assisted sulfide decreasing function and a pH lowering function. Although seen as separate functions, these functions may also be performed simultaneously and do not have to be performed concurrently. These will be described in more detail below.

Generally, the composition of a spent caustic stream, or spect caustic wastewater, is based on sulfides, mercaptans, thiosulfate, and phenols. The oxidation reactions of sulfide and other reduced sulfur compounds by ozone and hydrogen peroxide O₃/H₂O₂ (peroxone) can be used for industrial wastewater treatment.

The peroxone reaction function can generate the formation of hydroxyl radicals (.OH) during the reaction. The relative oxidation power of a hydroxyl radical is higher (2.05) than ozone (1.52) and hydrogen peroxide (1.31) independently. The addition of H₂O₂ to O₃ can initiate the decomposition of O₃, resulting in the formation of .OH radicals:

2O₃+H₂O₂→2.OH+3O₂

The formation of .OH during the peroxone reaction is controlled by a number of variables, including pH, temperature, peroxide concentration, ozone concentration and reaction time.

The typical reactions occurring during the oxidation of a spent caustic wastewater stream include the following:

S⁼+4H₂O₂→SO₄⁼+4H₂O (sulfides to sulfates at alkaline pH)
2RSH+H₂O₂→RSSR+2H₂O (thiols to disulfides at alkaline pH)
RSSR+5H₂O₂+2OH⁻→2RSO₃⁻+6H₂O (disulfides to sulfonic acids at alkaline pH)

Carrying the reaction to sulfonic acid and/or sulfates is generally enough to control odors and reduce the amount of sulfides to acceptable levels.

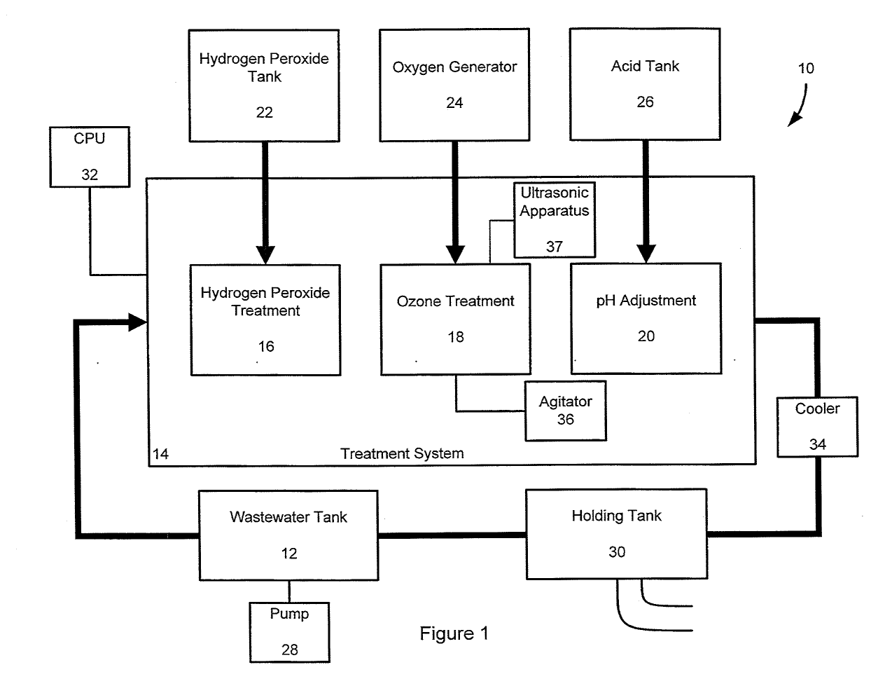

Turning to FIG. 1, a schematic diagram of a system for treatment of spent caustic wastewater is shown. The system 10 includes a wastewater tank 12 which is connected to an input of a treatment syste006D 14. The wastewater tank 12 contains the spent caustic wastewater, or wastewater, that is to be treated. In one exemplary embodiment, the volume of the wastewater tank 12 may be approximately 50,000 liters; however, the wastewater tank may be any suitable size. Although not shown, carbon pillows are preferably positioned to obstruct openings at the top of the tank 12 to inhibit or reduce the likelihood of the emission of offensive odors from the wastewater to the ambient environment.

The treatment system 14, which may be housed within a main equipment enclosure, includes the equipment that chemically treats the wastewater, namely, a hydrogen peroxide treatment apparatus 16 and a pH adjustment apparatus 20, by pumping hydrogen peroxide and acid, respectively, into the process stream, and an oxygen treatment apparatus 18 such as, but not limited to, ozone gas diffusers, that introduce ozone gas into the wastewater. The term “process stream” may be used interchangeable with the term “wastewater” in the current description and refers to the spent caustic wastewater as it is being pumped through the system 10.

The hydrogen peroxide treatment apparatus 16 is connected to a hydrogen peroxide tank 22, the oxygen treatment apparatus 18 is connected to an oxygen generator 24 and the pH adjustment apparatus 20 is connected to an acid tank 26. In a preferred embodiment, the hydrogen peroxide tank 22, the oxygen generator 24 and the acid tank 26 may also be housed within the main equipment enclosure and seen as part of the treatment system 14. In the current embodiment, a cooler 34, or coolant pump is located between an output of ht treatment system 14 and a holding tank 30. A central processing unit (CPU) 32 for controlling the treatment system 14 is also within the system 10. The control system, or CPU, continuously monitors data from the treatment system, such as, but not limited to, temperature, pressure, level and flow sensors, chemical analyzers and inputs from the user. The CPU 32 may also controls flow of process fluids and progression of the treatment process and enunciate warnings to the user and shuts the system down if an unsafe condition exists.

The holding tank 30 is also connected to the wastewater tank 12 for delivering treated wastewater if the treated wastewater is deemed to require further treatment. This may be because the treated wastewater is not clean enough or that the temperature of the treated wastewater needs to be further cooled or further pH treatment of the treated wastewater is required. The holding tank 30 may also output the treated wastewater to further devices for further processing.

The wastewater tank 12, the holding tank 30 and the treatment system 14 are all connected via piping allowing the wastewater to be transmitted between the wastewater tank 12, the holding tank 30 and the system 14 and vice-versa.

Although the treatment system 14 of FIG. 1 is shown with one hydrogen peroxide treatment apparatus 16, one oxygen treatment apparatus 18 and one pH adjustment apparatus 20, multiple apparatus may be included in the treatment system 14 and only one is shown for clarity and ease of display.

An agitator 36, or machine for producing a mechanical catalyst in the form of agitation, such as by a disk mixer, is located within the treatment system 14, for agitating an output of the oxygen treatment apparatus 18 thereby accelerating the chemical reactions. In other words, the agitator 36 may be seen as being downstream from the oxygen treatment apparatus 18. The system 10 further includes an ultrasonic irradiation apparatus 37 which provides ultrasonic irradiation to the mixture being treated in order to create cavitation bubbles.

In a preferred embodiment, the oxygen treatment apparatus 18, the agitator 36 and the ultrasonic irradiation apparatus 37 may be combined as one apparatus to deliver ozone gas and provide ultrasonic agitation. For example, this combined apparatus may be a 12-inch USO3 system (“USO3”) offered by Ultrasonic Systems GmbH, having an address at Gemeindewald 7a, 86672 Thierhaupten, Germany.

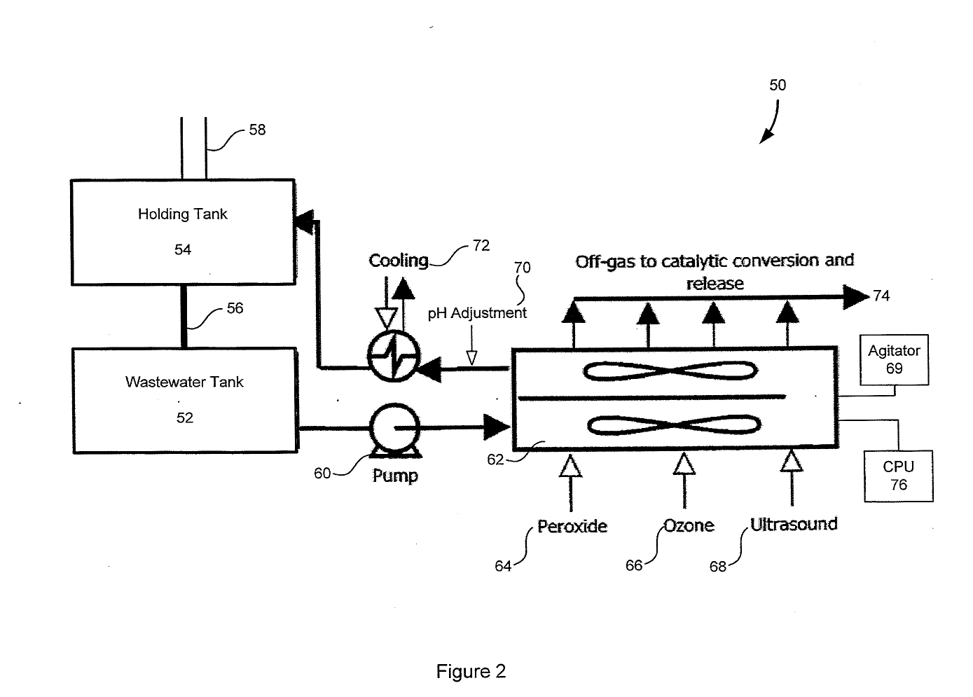

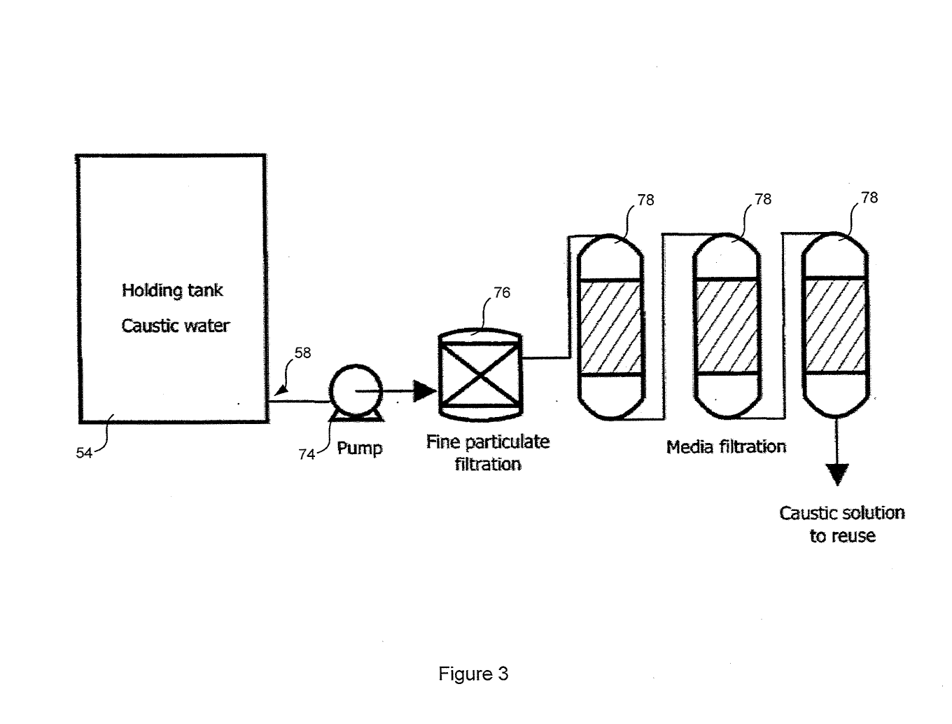

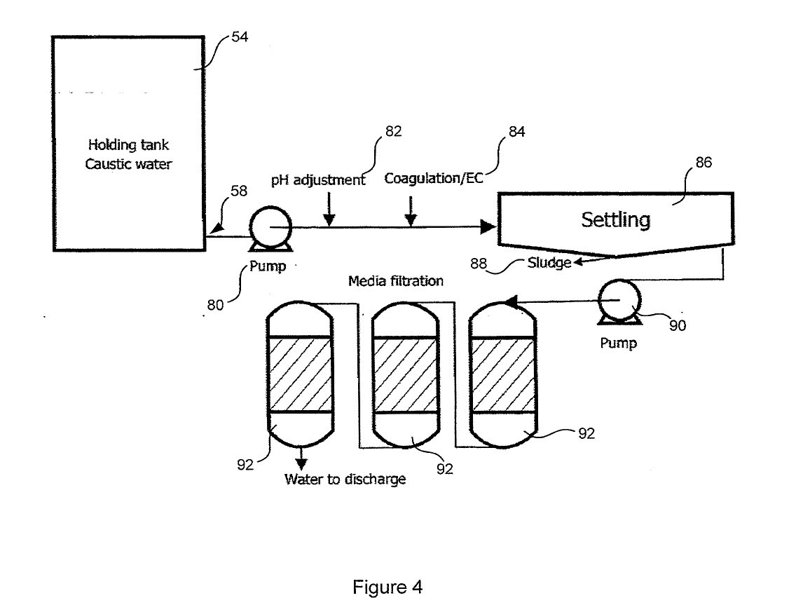

Turning to FIG. 2, a schematic diagram of another embodiment of apparatus for treating spent caustic wastewater is shown. In this embodiment, a system 50 includes a wastewater tank 52 (which stores the wastewater to be treated, preferably at ambient temperature) and a holding tank 54 (which stores treated wastewater). The holding tank 54 has at least two outputs, with one output 56 connected to the wastewater tank 52 if the treated wastewater needs further treatment and a second output 58 which delivers the treated wastewater for further processing (such as to the apparatus shown in FIGS. 3 and 4).

A pump 60 pumps the wastewater from the tank 52 to a treatment system 62. Inputs to the treatment system 62 include, but may not be limited to, peroxide (from a hydrogen peroxide tank 64) and ozone (from an oxygen generator 66). A mechanical catalzyer 69, in the form of a disk mixer or agitator, and an ultrasonic irradiation machine 68, are also connected to the treatment system 62 for providing a mechanical catalyst to assist in accelerating chemical reactions and to provide ultrasonic cavitation, respectively, as discussed above. After the wastewater has been treated by the treatment system 62, the pH of the treated wastewater is adjusted by a pH adjustment apparatus 70.

The treated wastewater is then cooled via a cooler 72 before being delivered or pumped back into the holding tank 54. During the treatment process, gases may be emitted from the treatment system which are treated via a catalytic conversion process and then released into the environment such as shown by arrow 74. A CPU 76 controls the treatment system 62.

FIGS. 3 and 4 show apparatus for further processing of the treated wastewater. These apparatus, or further processing, may provide further benefit to the treated wastewater but are optional to the treatment process of the disclosure.

Turning to FIG. 3, an output of the holding tank 54 is pumped (via pump 74) through the second output 58. The treated wastewater is then passed through a filter 76 which assists in performing fine particulate filtration of the treated wastewater to remove suspended solids and fine oil droplets. The treated wastewater is then passed, or pumped, through a series of media filtration devices 78 to remove trace impurities such as, but not limited to residual organics, colour compounds and/or odor compounds. In one embodiment, the media filtration devices 78 employ activated carbon, bentonite and/or organically modified clay, and activated alumina. The output from the media filtration devices (which is preferably a caustic solution) may then be re-used.

Turning to FIG. 4, an output of the holding tank 54 is pumped (via a pump 80) through the second output 58 (or possibly another output of the holding tank 54) through a pH adjustment 82 and a coagulation/electro-coagulation apparatus 84. Although not shown, the output of the holding tank 54 may also pass a fine filtration device (such as the filter 76 of FIG. 3) before passing through the pH adjustment.

As understood, at the pH adjustment 82, the treated wastewater is treated by an acid such as hydrochloric or sulfuric at any concentration, to bring down the pH of the treated wastewater to a point where the coagulation may be more efficiently performed. The coagulation/electro-coagulation apparatus performs coagulation/flocculation and clarification of the treated wastewater.

The output from the coagulation/electro-coagulation apparatus is then pumped into a settling apparatus, or area 86. Within the settling apparatus 86, sludge 88 may be removed from the wastewater before that wastewater (which may be seen as clarified water) is pumped, via a second pump 90, through a series of media filtration devices 92 and then the treated wastewater (or clarified water) discharged.

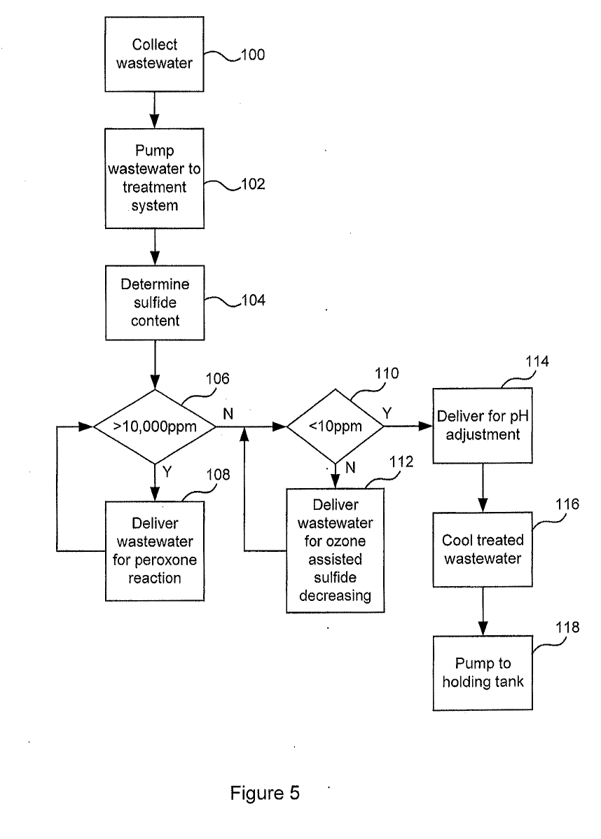

Turning to FIG. 5, a flowchart outlining a method of treating spent caustic wastewater is shown. This method is related to the system of FIG. 1. Initially, the wastewater is collected in the wastewater tank (100). The wastewater may be either deposited into an empty wastewater tank 12 that is already connected to a treatment system 14 or the treatment system 14 may be connected up to a wastewater tank 12 that is already full of or holding wastewater to be treated. As will be understood, the collection of wastewater may not be part of the treatment process as a wastewater tank full of wastewater may be provided by an external party, such as a customer.

The wastewater is preferably filtered to remove solid particulates prior to the treatment process. Alternatively, a filter (not shown) may be placed within the piping between the wastewater tank 12 and the treatment system 14 to filter out solid particulates. In yet a further embodiment, the filtering may be performed by a self cleaning filter system (downstream of the feed pump 28) to remove impurities from the wastewater.

The wastewater is then pumped, such as by the feed pump 28, from the wastewater tank 12 to the treatment system 14 (102). A level of sulfide content in the wastewater is then determined (104) to assist in determining a treatment for the wastewater. In one embodiment, the level of sulfide within the wastewater is measured by a sensor and then a treatment based on this measurement determined. In another embodiment, the level of sulfide is measured at a lab and then the measurements entered into the CPU 32 to determine the level of treatment. In yet another embodiment, a treatment is inputted into the CPU 32 which then translates the input or inputs into instructions for the treatment system 14.

Depending on the total sulfide content, the wastewater may be transmitted to either the hydrogen peroxide treatment apparatus 16, the oxygen treatment apparatus 18 (and agitator 36) or the pH adjustment apparatus 20.

If the total sulfide content is greater than about 10,000 ppm (106), the wastewater is delivered to the hydrogen peroxide treatment apparatus 16 and subjected to a peroxone reaction function (108). This function includes combining the wastewater with hydrogen peroxide which is pumped in via the hydrogen peroxide tank 22. Although not shown in the Figures, the apparatus for pumping in the hydrogen peroxide will be understood by one skilled in the art.

In one embodiment, the peroxone reaction function decreases the total sulfides in the wastewater by oxidizing them with a combination of hydrogen peroxide (H₂O₂), ozone gas (O₃) and ultrasonic agitation. As will be understood, the wastewater may be subjected to treatment by both the hydrogen peroxide apparatus 16 and the oxygen treatment apparatus 18 at the same time as the apparatus for the oxygen treatment apparatus 18 generally includes mixers for mixing the wastewater with the ozone and the hydrogen peroxide. As the treatment by the hydrogen peroxide apparatus 16 continues, the sulfide content is continuously monitored (106).

To start the peroxone reaction, a metered amount of hydrogen peroxide is added to the wastewater which oxidizes the sulfide contaminants in it. The hydrogen peroxide is preferably added by a variable speed pump. This allows the rate of hydrogen peroxide addition to be adjustable. The rate of hydrogen peroxide addition and the concentration of hydrogen peroxide solution being added are dependent upon the particular chemical characteristics of the wastewater being treated.

If the total sulfide content is not greater than 10,000 ppm and is not less than 10 ppm (110), the wastewater, either from the wastewater tank 12 if the original determination of total sulfide content (in 106) is less than 10,000 ppm and not less than 10 ppm or the hydrogen peroxide apparatus 18 after the total sulfide content has been reduced via the peroxone reaction function to is less than 10,000 ppm and not less than 10 ppm, is delivered to the oxygen treatment apparatus (112) where the flow rate of ozone gas into the treatment system is also adjustable.

This ozone assisted sulfide decreasing function decreases the total sulfides in the wastewater to acceptable levels with a combination of ozone gas, mechanical agitation and ultrasonic irradiation. The rate of ozone gas addition and the concentration of ozone gas being added are dependent upon the particular chemical characteristics of the wastewater being treated as measured. As the treatment by the oxygen treatment apparatus 18 and agitator 36 continues, the sulfide content is continuously monitored.

If the total sulfide content is less than 10 ppm (at 110), the wastewater, either from the wastewater tank 12 if the original determination of total sulfide content (in 106) is less than 10 ppm or the oxygen treatment apparatus after the total sulfide content has been reduced via the ozone assisted sulfide decreasing function to less than 10 ppm, is delivered (114) to the pH adjustment apparatus 20.

The third function, which may be seen as a pH lowering function, assists in lowering the pH of the wastewater being treated. This pH adjustment is done by adding a metered amount of acid to the wastewater being treated to lower its pH, preferably to approximately 7 on the pH scale. The acid is preferably added by a variable speed pump which allows the rate of acid addition to be adjusted, if needed. The concentration of acid and the rate of addition of the acid are dependent upon the particular chemical characteristics of the wastewater being treated.

A typical caustic neutralization reaction using hydrochloric acid is as follows:

NaOH+HCl→NaCl+H₂O

Because pH adjustment is only done when the wastewater no longer contains high levels of sulfides, the release of harmful gasses into the environment can be effectively limited and/or controlled.

Typical sulfidic spent caustic chemical composition and treatment results are given in Table 1.

TABLE 1
Influent Sulfidic Spent Caustic Composition and Treatment results

| | | Sulfidic Effluent before |
|---|---|---|
| | | additional |
| Parameter [mg/L] | Sulfidic Influent | treatment/polishing |
| pH | 12-12.7 | 8.2-9.0 |
| COD | 30,000-70,000 | 1,100-6,700 |
| TOC | 7,200-14,800 | 1,180-2,050 |
| Sulfides | 27,000-42,000 | <1 |
| Sulfite | 30-74 | <1 |
| Mercaptans | 3,800-6,900 | <10 |
| Thiosulfate | 420-710 | <20 |
| Phenols | 0-12 | <1 |

After exiting the pH adjustment apparatus, the treated wastewater may then be cooled (116) before being pumped (118) to the holding tank 30. If the level of sulfide content in the treated wastewater is not low enough or if other properties of the treated wastewater do not meet expected criteria, the treated wastewater may be pumped to the wastewater tank 12 and the treatment process repeated. Otherwise, the treated wastewater may be processed further, such as by the apparatus shown in FIGS. 3 and 4.

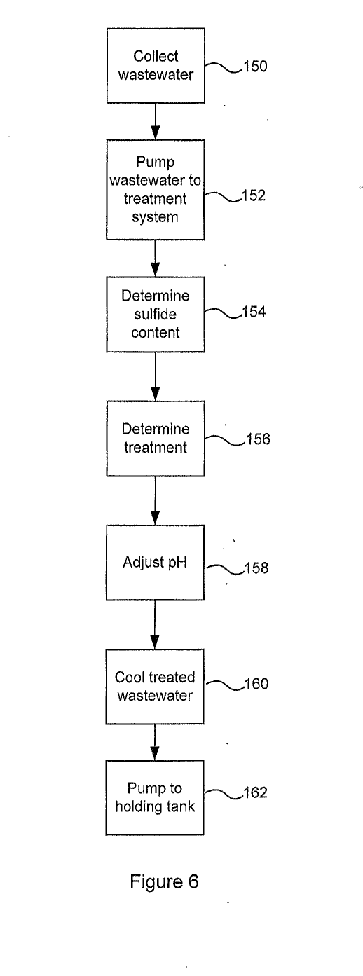

Turning to FIG. 6, a flowchart outlining a method of treating spent caustic wastewater with respect to the embodiment of FIG. 2 is shown. Initially, the wastewater is collected in the wastewater tank 52 (150). The wastewater may be either deposited into an empty wastewater tank 52 that is already connected to a treatment system 62 or the treatment system 62 may be connected up to a wastewater tank 52 that is already full of or holding wastewater to be treated. The wastewater is preferably filtered to remove solid particulates prior to the treatment process, as described above.

The wastewater is then pumped, such as by the feed pump 60, from the wastewater tank 52 to the treatment system (152). A level of sulfide content in the wastewater is then determined (154) to assist in determining a treatment for the wastewater. Different ways of measuring the level of sulfide content are disclosed above.

After determining the level of sulfide content in the wastewater, a treatment is then determined (156). In the current embodiment, which may be seen as a one-pass system wherein the peroxone reaction function and the ozone-assisted sulfide decreasing function are performed simultaneously, the level of sulfide content is inputted into the CPU 76 which determines the necessary amounts of peroxide 64 and ozone 66 for the treatment process along with the level of agitation by the agitator 69 and ultrasonic irradiation by the ultrasound apparatus 68.

A typical flow ratio of hydrogen-peroxide to the spent caustic wastewater is 0.01-0.03 to 1.0, depending on the type and chemical composition of the spent caustic stream. Liquid hydrogen-peroxide can be injected into a flow-through reactor (containing the wastewater to the treated) at a single injection point or multi-port points. Upon injection of liquid hydrogen-peroxide, a raid mixing zone of the flow-through reactor is entered to ensure contact between the liquid streams of hydrogen peroxide and the spent caustic wastewater. In one embodiment, the mixing or mechanical agitation is achieved by using a disk mixer, preferably rotating between about 1,000 to about 3,000 resolutions per minute.

At the same point or almost simultaneously, an ozone stream is introduced into the treatment system 62 or wastewater. A mass ratio of hydrogen-peroxide to ozone is kept within 10-15 to 1.0 to ensure safe and efficient operation. The disk mixer provides instantaneous dispersion of ozone in the bulk of the spent caustic wastewater and hydrogen-peroxide mixture, where ozone and peroxide (combined to form peroxone) create so called peroxone oxidizing conditions as added hydrogen peroxide and/or ultrasound radiation accelerates the decomposition of ozone and increases the hydroxyl radical concentration. A key difference between the ozone and peroxone processes is that the ozone process relies heavily on the direct oxidation of aqueous ozone while peroxone relies primarily on oxidation with hydroxyl radical. In the peroxone process, the ozone residual is short lived because the added hydrogen-peroxide greatly accelerates the ozone decomposition. However, the increased oxidation achieved by the hydroxyl radical greatly outweighs the reduction in direct ozone oxidation because the hydroxyl radical is much more reactive. The net result is that oxidation is more reactive and much faster in the peroxone process compared to the ozone assisted sulfide decreasing function, which allows the method of the disclosure to faster and/or more efficient than current solutions.

In addition, the chemical oxidation process is supported and accelerated by the agitation, or irradiation, caused by ultrasound apparatus or the agitator. It has been observed that ultrasound can greatly enhance chemical reactivity in a number of systems by as much as a million-fold; effectively acting as a catalyst by exciting the atomic and molecular modes of the treatment system (such as, but not limited to, vibrational, rotational, and translational modes). The effects of ultrasound do not typically come from a direct interaction with molecular species but sonochemistry and sonoluminescence arises from acoustic cavitation: the formation, growth, and implosive collapse of bubbles in a liquid. Cavitational collapse produces intense local heating (5000 K), high pressures (1000 atm), and enormous heating and cooling rates (>10 9 K/sec). Acoustic cavitation provides a unique interaction of energy and matter, and ultrasonic irradiation of liquids causes high energy chemical reactions to occur, and yet not changing the temperature of the liquid medium in which it is introduced.

In a preferred embodiment, the irradiation by ultrasound is in the range of 20-150 kHz, depending on the target chemical compounds to be oxidized (long strait chain, phenolics, cresylics, etc.). Generally, the rate of homogeneous sonochemical reaction decreases with a rise of the bulk liquid temperature. The complex oxidation process of the chemical compounds in the treated wastewater continues after the treated wastewater exits the treatment system 62.

In some embodiments, given that the oxidation reactions of the chemical compounds found in the spent caustic wastewater are exothermic in nature, the heat released during the treatment process and the temperature of the treated wastewater rises in the treatment system 62. To counteract the heat generation, which may dramatically reduce the oxidation rate of sulfides and therefore reduce process efficiency, the flow of the spent caustic wastewater is in part or completely run through a heat exchanger during the treatment process. Typically, the operating temperature of the treatment process is between about 0-25 degrees Celsius. Due to a low operating temperature range, most of the oil dispersed in the spent caustic wastewater is not oxidized and will end up as a floating layer in a spent caustic tank ready for separation.

After completing the treatment of the wastewater via the addition of the peroxone, an output of the treatment system 62 is then passed through the pH adjustment apparatus 70 (158) which adds an acid to the output in order to balance the treated wastewater. The output from the pH adjustment apparatus is then cooled (160) before being pumped to the holding tank 54 (162). As with the method of FIG. 5, if the characteristics of the treated wastewater do not meet certain criteria, the treated wastewater in the holding tank 54 may be pumped back to the wastewater tank 52 to be treated again. Alternatively, if the characteristics of the treated wastewater do meet certain criteria, the treated wastewater may be delivered for further processing such as by the apparatus in FIGS. 3 and 4 as discussed above.

In an alternative embodiment, during the treatment process, any gas formation may be vented though a set of gas collection lines from the treatment system into a gas catalytic converter—where all harmful gaseous compounds, such as hydrogen-sulfide, mercaptans and unreacted ozone, may be effectively destroyed before being released into the atmosphere.

In other embodiments, other oxidation and ultrasonic and/or mechanical agitation systems other than a USO3 system may be used. A treatment system may comprise a plurality of individual systems and components connected together, for example as a permanent on site treatment facility.

In another embodiment, the CPU and electrical distribution systems are located inside the main equipment enclosure. The electrical distribution system provides electrical power and overcurrent protection for all of the system's electrical devices.

In yet a further embodiment, hydrogen sulfide and ozone gas detectors are located in the main equipment enclosure and monitored by the control system or CPU. The sensors, in combination with the CPU, may enunciate an alarm and shut down the treatment system if hydrogen sulfide or ozone gas is detected outside of the process piping in excess of predetermined levels (i.e. leakage). For instance, this may occur if hydrogen sulfide or ozone gas is detected outside of the process piping at levels over 10 parts per million (ppm) or 0.1 ppm, respectively. If leakage is detected, the treatment system may be is stopped, drained and purged immediately (indicated by a red signal light on the container roof). In addition, ventilators instantaneously start to remove the toxic gases and ventilate all rooms inside the container. The ventilated air is fed through carbon filters to limit harmful gas escape into the environment.

In another embodiment, the process feed pump, filter and heat exchanger may be contained in a single module whereby the pump circulates the wastewater through the treatment system, the filter removes suspended solids from the wastewater, and the heat exchanger that removes the heat that is generated from chemical reactions in the treatment process preferably maintaining a process temperature below 30° C.

In one embodiment, the hydrogen peroxide tank contains an aqueous solution of hydrogen peroxide, and the acid tank contains an acid solution. The particular acid that is utilized varies, depending upon availability and the chemical characteristics of the wastewater being treated. In one preferred embodiment, the volume of the hydrogen peroxide tank and the volume of the acid tank are each 1,000 liters.

In a preferred embodiment, the gas catalyzer module 74 includes two catalyzers that utilize oxygen gas and a granular catalyst to remove ozone and hydrogen sulfide gases from the process and convert them to benign gases before releasing them to the atmosphere.

The oxygen generator 24 may include a machine that extracts oxygen from the surrounding atmosphere to supply the oxygen gas that feeds the ozone gas generator and catalyzers.

In yet another embodiment. all materials that are in contact with the wastewater (e.g. the piping are either stainless steel or non-metallic materials that have been designed to convey the corrosive chemicals present in the wastewater.

Experiments

Various experiments using the above-described system and method have been performed with the results listed below.

The below tables present the key parameters on the spent caustic influent and effluent based on the treatment as described by this invention. The experiments took part in a laboratory setting (up to 20 litre in size), then at a pilot level (1000 litre), then in a real batch setting (over 30,000 litre)

Case 1. Treatment of refinery sulfidic
spent caustic (370,000 litre treated)

| | | Sulfidic Effluent before |
|---|---|---|
| | | additional |
| Parameters [mg/L] | Sulfidic Influent | treatment/polishing |
| pH | 13.5 | 10.2 |
| COD | 94,000 | 7,700 |
| TOC | 14,800 | 2,050 |
| Sulfides | 67,000 | <1 |
| Sulfite | 74 | <1 |
| Mercaptans | 1,100 | <1 |
| Thiosulfate | 370 | <1 |
| Phenols | 86 | <1 |

Case 2. Treatment of refinery naphthenic
spent caustic (110,000 litre)

| | | Naphthenic Effluent before |
|---|---|---|
| | | additional |
| Parameters [mg/L] | Naphthenic Influent | treatment/polishing |
| pH | 13.7 | 9.6 |
| COD | 74,000 | 6,700 |
| TOC | 17,800 | 1,820 |
| Sulfides | 1,100 | <1 |
| Sulfite | 30 | <1 |
| Mercaptans | 2 | <1 |
| Thiosulfate | 140 | <1 |
| Phenols | 4,800 | <1 |

Case 3. Treatment of refinery cresylic spent caustic (147,000 litre)

| | | Cresylic Effluent before |
|---|---|---|
| | | additional |
| Parameters [mg/L] | Cresylic Influent | treatment/polishing |
| pH | 13.2 | 7.8 |
| COD | 136,000 | 11,200 |
| TOC | 27,800 | 3,850 |
| Sulfides | 22,600 | <1 |
| Sulfite | 310 | <1 |
| Mercaptans | 3,400 | <1 |
| Thiosulfate | 6,900 | <1 |
| henols | 12,800 | <1 |

Case 4. Recovery of the caustic solution from spent caustic,
after the advanced oxidation process (51,000 litre)

| Parameter | Starting | Ending |
|---|---|---|
| pH | 13.2 | 11.7 |
| Suspended solids (mg/L) | 700 | <20 |
| colour | brown | pale yellow |

Case 5. Treatment of spent caustic to the
water discharge level (270,000 litre)

| Parameters [mg/L] | Sulfidic spent caustic | Water effluent |
|---|---|---|
| pH | 12.5 | 7.4 |
| COD | 56,000 | 520 |
| TOC | 17,300 | 310 |
| Sulfides | 29,400 | <1 |
| Sulfite | 370 | <1 |
| Mercaptans | 2,400 | <1 |
| Thiosulfate | 320 | <1 |
| Phenols | 67 | ND |
| Oil | 610 | 5 |

In yet another embodiment, the system for treating spent caustic wastewater includes a plurality of modular components that are designed to be transported to a client's, or off-site, facility, assembled and operated there temporarily to treat wastewater that has accumulated and is stored there. Upon project completion, the system is disassembled and removed. By treating the wastewater at the site, the risk of a potentially hazardous wastewater spill during highway transport is obviated. However, the system may also be a permanent fixture whereby wastewater is transported to the system.

The present description is provided by way of example. It will be apparent to persons skilled in the art that a number of variations and modifications can be made without departing from the scope of the claims.

What is claimed is:

1. A system for treating spent caustic wastewater comprising:
a treatment system including:
a hydrogen peroxide apparatus for mixing hydrogen peroxide with the spent caustic wastewater;
an oxygen treatment apparatus for mixing ozone with the spent caustic wastewater;
a pH adjustment apparatus for mixing acid with the spent caustic wastewater;
an agitator for providing a mechanical catalyst to an output of the oxygen treatment apparatus;
an ultrasound apparatus to assist in accelerating chemical reactions between the spent caustic wastewater and the ozone;
wherein the combination of hydrogen peroxide, ozone and spent caustic wastewater and the mechanical catalyst produce a treated wastewater.

2. The system of claim 1 wherein the hydrogen peroxide and the ozone are combined to form peroxone and the agitator provides the mechanical catalyst for accelerating the chemical reaction between the spent caustic wastewater and peroxone.

3. The system of claim 1 further comprising a coolant pump for cooling the treated wastewater.

4. The system of claim 1 further comprising:
a wastewater tank, connected to an input of the treatment system, for holding the spent caustic wastewater; and
a holding tank, connected to an output of the treatment system, for holding the treated wastewater.

5. The system of claim 4 further comprising a pump for pumping the spent caustic wastewater from the wastewater tank to the holding tank.

6. The system of claim 1 further comprising:
a hydrogen peroxide tank for supplying hydrogen peroxide to the hydrogen peroxide apparatus;
an oxygen generator for supplying ozone to the oxygen treatment apparatus; and
an acid tank for providing an acid to the pH adjustment apparatus.

7. A method of treating spent caustic wastewater comprising:
adding hydrogen peroxide to the spent caustic wastewater;
adding ozone to the spent caustic wastewater;
applying a mechanical catalyst to the mixture of hydrogen peroxide, ozone and spent caustic wastewater to accelerate chemical reactions;
applying ultrasound cavitation to the mixture; and
adding an acid to the mixture to balance a pH of the mixture.

8. The method of claim 7 further comprising:
cooling the pH balanced mixture.

9. The method of claim 7 wherein the mechanical catalyst is via mechanical vibrations.

10. The method of claim 7 wherein the ultrasonic cavitation is performed by ultrasonic irradiation.

11. The method of claim 7 further comprising, before adding hydrogen peroxide, determining a treatment for the spent caustic wastewater.

12. The method of claim 11 wherein determining the treatment for the spent caustic wastewater comprises:
determining a sulfide content level within the spent caustic wastewater;
determining a level of hydrogen peroxide and ozone required to treat the determined sulfide content level; and
determining a level of mechanical catalyst to be applied to accelerate the chemical reactions.

13. The system of claim 1 further comprising a central processing unit for controlling the treatment system.
